(19) United States
(12) Patent Application Publication
(10) Pub. No.: US 2016/0342002 A1
(43) Pub. Date: Nov. 24, 2016

(54) DISPLAY SUBSTRATE AND MANUFACTURING METHOD THEREOF AND DISPLAY DEVICE

(71) Applicant: BOE TECHNOLOGY GROUP CO., LTD., Beijing (CN)

(72) Inventor: Guangkui QIN, Beijing (CN)

(21) Appl. No.: 14/785,712

(22) PCT Filed: Apr. 17, 2015
(86) PCT No.: PCT/CN2015/076839

§ 371 Date: Oct. 20, 2015

(30) Foreign Application Priority Data
Nov. 20, 2014 (CN) 201410670053.4

(51) Int. Cl. G02F 1/13363; G02F 1/1335; G02F 1/1337; G02F 1/1333

(52) U.S. Cl. CPC G02F 1/13363; G02F 1/133365; G02F 1/133512; G02F 1/133514; G02F 1/1337; G02F 2202/022; G02F 2413/08

(57) ABSTRACT

A display substrate for a liquid crystal display device, a manufacturing method thereof and a liquid crystal display device are provided. The display substrate comprises a first base substrate, a phase retardation layer and a first alignment layer. The phase retardation layer is located above the first base substrate, and the first alignment layer is located above the phase retardation layer; the phase retardation layer is configured to perform phase retardation on light entering the phase retardation layer, and a direction of phase retardation generated by the phase retardation layer is vertical to a direction of phase retardation generated by the liquid crystal in the liquid crystal display device. With the above technical solutions provided by the present invention, the phase retardation generated by the liquid crystal is counteracted by the phase retardation generated by the phase retardation layer, thereby avoiding serious dark-state light leakage and improving the contrast.

### FIELD OF THE INVENTION

The present invention relates to the technical field of display, in particular to a display substrate for a liquid crystal display device and a manufacturing method thereof and a liquid crystal display device.

### BACKGROUND OF THE INVENTION

A glass substrate in a Liquid Crystal Display (LCD) is of isotropic material and will not generate phase retardation, so the liquid crystal display will not generate light leakage under normal circumstances. However, when the liquid crystal display is subjected to an external force, the property of the glass substrate will become anisotropic under the action of the external force so that phase retardation will be generated. According to different forced directions, directions of generation of the phase retardation are different too.

The cause of dark-state light leakage will be described below by comparing the states of an empty cell and a liquid crystal cell under a bending pressure. FIG. 1a is a schematic diagram when an empty cell generates phase retardation under a bending force, and FIG. 1b is a schematic diagram of a change, expressed by a Poincare sphere, of a polarization state when light passes through the empty cell of FIG. 1a.

As shown in FIG. 1a, the empty cell comprises a color filter substrate 101 and an array substrate 201 which are arranged opposite to each other, a polarizer is provided on an outer side (a side not facing the array substrate 201) of the color filter substrate 101, and a polarizer is provided on an outer side (a side not facing the color filter substrate 101) of the array substrate 201, and there is no liquid crystal provided between the color filter substrate 101 and the array substrate 201, wherein the polarizers are not shown. As shown in FIG. 1a, the color filter substrate 101 is subjected to an expansion force (a direction of deformation is represented by an outward arrow) and the array substrate 201 is subjected to a compression force (a direction of deformation is represented by an inward arrow), so the forced direction of the color filter substrate 101 is vertical to that of the array substrate 201. A direction of generation of phase retardation depends on the stress. Hence, when the empty cell is bent under an external pressure, the direction of the phase retardation generated by the color filter substrate 101 is vertical to that of the phase retardation generated by the array substrate 201. Therefore, the phase retardation generated by the color filter substrate 101 and the phase retardation generated by the array substrate 201 may counteract each other, so that the empty cell will not generate dark-state light leakage when the empty cell is bent under the external pressure.

As shown in FIG. 1b, a black point indicated by S1 represents an initial polarization state position of the polarization state on the spherical surface of the Poincare sphere. Three uppermost points represent changed positions of the polarization state after phase retardations are generated for red light, green light and blue light passing through a lower glass substrate respectively. As shown by a downward arrow, at an empty cell state or in the case of the liquid crystal display panel being a vertical alignment (VA) panel, the polarization state returns to the initial point S1 again after the three colors of lights are subjected to the phase retardation action of an upper glass substrate.

FIG. 2a is a schematic diagram when a liquid crystal cell generates phase retardation under a bending pressure, FIG. 2b is a schematic diagram of a change, expressed by a Poincare sphere, of a polarization state when light passes through the liquid crystal cell of FIG. 2a, and FIG. 2c is a schematic diagram of a light leakage state of the liquid crystal cell under an external pressure.

As shown in FIG. 2a, the liquid crystal cell includes a color filter substrate 101 and an array substrate 201 which are arranged opposite to each other, a polarizer is provided on an outer side of the color filter substrate 101, a polarizer is provided on an outer side of the array substrate 201, and a liquid crystal layer 3 is provided between the color filter substrate 101 and the array substrate 201, wherein the polarizers are not shown. When the liquid crystal cell is bent under an external pressure, all the color filter substrate 101, the array substrate 201 and the liquid crystal layer 3 will generate phase retardation. However, as the direction of phase retardation generated by the color filter substrate 101 is vertical to the direction of phase retardation generated by the array substrate 201 and amount of the phase retardation generated by the color filter substrate 101 is equal to that of the phase retardation generated by the array substrate 201 (for example, each of the both is 3 nm), the phase retardation generated by the color filter substrate 101 and the phase retardation generated by the array substrate 201 counteract each other. However, as the phase retardation generated by the liquid crystal layer 3 is not counteracted, this will result in serious dark-state light leakage, so that the contrast of the display device is degraded.

In conclusion, when a liquid crystal display device is bent under an external force, the phase retardation generated by the liquid crystal layer 3 will result in serious dark-state light leakage, so that the contrast of the display device is degraded.

### SUMMARY OF THE INVENTION

The present invention provides a display substrate and a manufacturing method thereof and a display device in order to improve the contrast.

To achieve the above objective, the present invention provides a display substrate for a liquid crystal display device, including a first base substrate, a phase retardation layer and a first alignment layer, wherein the phase retardation layer is located above the first base substrate, and the first alignment layer is located above the phase retardation layer; and the phase retardation layer is configured to perform phase retardation on light entering the phase retardation layer, and a direction of phase retardation generated by the phase retardation layer is vertical to a direction of phase retardation generated by a liquid crystal layer in the liquid crystal display device.

Optionally, the phase retardation layer includes a third alignment layer and a liquid crystal polymer layer located above the third alignment layer; and in the case of the display substrate being not subjected to an external force, a direction of an optical axis of a liquid crystal polymer in the liquid crystal polymer layer is vertical to a direction of an optical axis of liquid crystal in the liquid crystal layer.

Optionally, the liquid crystal in the liquid crystal layer has a polarity which is the same as or different from that of the liquid crystal polymer in the liquid crystal polymer layer.

Optionally, the liquid crystal polymer layer is a thermotropic liquid crystal layer or a lyotropic liquid crystal layer.

Optionally, there is a difference between amount of the phase retardation generated by the phase retardation layer and that of the phase retardation generated by the liquid crystal layer, or amount of the phase retardation generated by the phase retardation layer is equal to that of the phase retardation generated by the liquid crystal layer.

Further optionally, an absolute value of the difference is less than or equal to 50 nm and greater than 0.

To achieve the above objective, the present invention provides a liquid crystal display device, including a display substrate and an opposed substrate which are arranged opposite to each other, wherein a liquid crystal layer is provided between the display substrate and the opposed substrate; the display substrate is the display substrate described above; and the opposed substrate includes a second base substrate and a second alignment layer located above the second base substrate.

Optionally, the liquid crystal display device comprises an advanced super dimension switch liquid crystal display device or an in-plane switching liquid crystal display device.

The liquid crystal display device may be an Advanced Super Dimension Switch (ADS) liquid crystal display device or an In-Plane Switching (IPS) liquid crystal display device.

To achieve the above objective, the present invention provides a method for manufacturing a display substrate for a liquid crystal display device, including the following steps of: forming a phase retardation layer above a first base substrate, a direction of phase retardation generated by the phase retardation layer being vertical to a direction of phase retardation generated by a liquid crystal layer in the liquid crystal display device; and forming a first alignment layer above the phase retardation layer.

Optionally, the phase retardation includes a third alignment layer and a liquid crystal polymer layer; and the step of forming the phase retardation layer above the first base substrate includes: forming the third alignment layer above the first base substrate; and forming the liquid crystal polymer layer above the third alignment layer, wherein the third alignment layer is formed such that a direction of an optical axis of a liquid crystal polymer in the liquid crystal polymer layer above the third alignment layer is vertical to a direction of an optical axis of liquid crystal in the liquid crystal layer.

The present invention has the following beneficial effects:

in the technical solutions of the display substrate for a liquid crystal display device and manufacturing method thereof and the liquid display device provided by the present invention, a direction of phase retardation generated by the phase retardation layer is vertical to a direction of phase retardation generated by the liquid crystal in the liquid crystal display device, so the phase retardation generated by the liquid crystal may be counteracted or partially counteracted by the phase retardation generated by the phase retardation layer, thereby avoiding serious dark-state light leakage and improving the contrast.

### BRIEF DESCRIPTION OF THE DRAWINGS

FIG. 1a is a schematic diagram when an empty cell generates phase retardation under a bending force;

FIG. 1b is a schematic diagram of a change, expressed by a Poincare sphere, of a polarization state when light passes through the empty cell of FIG. 1a;

FIG. 2a is a schematic diagram when a liquid crystal cell generates phase retardation under a bending pressure;

FIG. 2b is a schematic diagram of a change, expressed by a Poincare sphere, of a polarization state when light passes through the liquid crystal cell of FIG. 2a;

FIG. 2c is a schematic diagram of a light leakage state of the liquid crystal cell under an external pressure;

FIG. 3 is a structural schematic diagram of a display substrate for a liquid crystal display device provided by a first embodiment of the present invention;

FIG. 4 is a structural schematic diagram of a liquid crystal display device provided by a second embodiment of the present invention;

FIG. 5a is a schematic diagram of a light leakage state in the case of the liquid crystal display device of FIG. 4 being not subjected to an external pressure;

FIG. 5b is a schematic diagram of a light leakage state in the case of the liquid crystal display device of FIG. 4 being subjected to an external pressure; and

FIG. 6 is a flowchart of a method for manufacturing a display substrate for a liquid crystal display device provided by a third embodiment of the present invention.

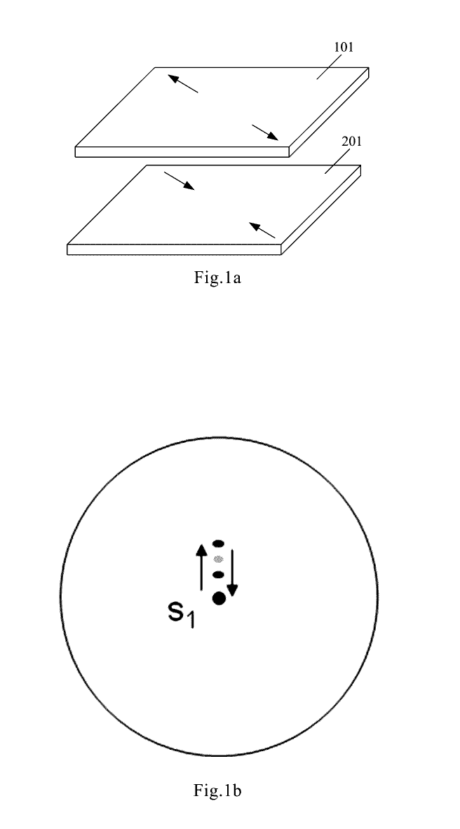

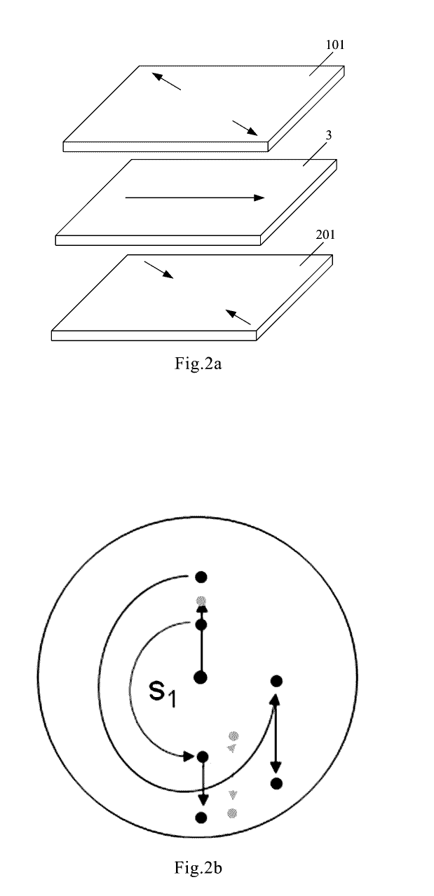

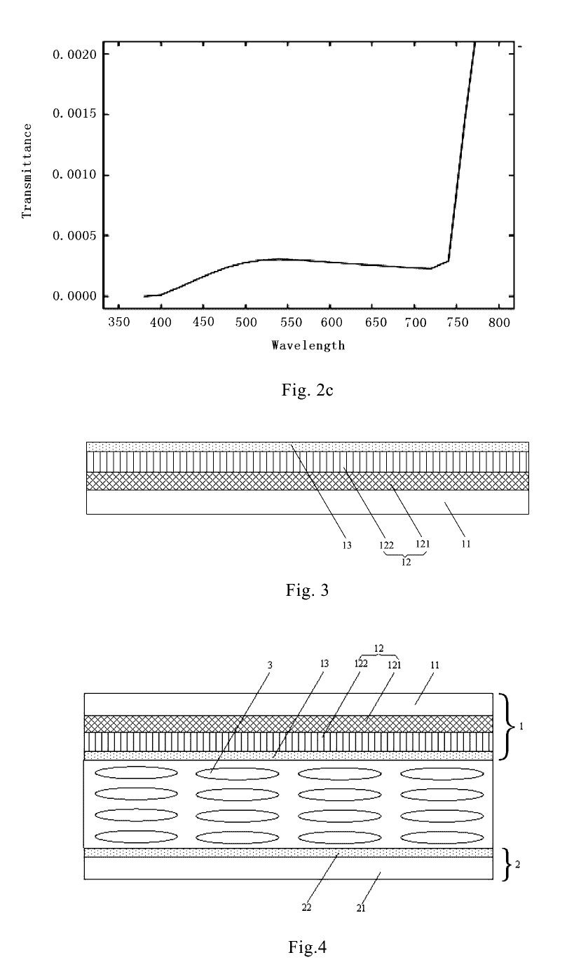

### DESCRIPTION OF THE PREFERRED EMBODIMENT

To make those skilled in the art better understand the technical solutions of the present invention, the display substrate for a liquid crystal display device and manufacturing method thereof and the liquid crystal display device provided by the present invention will be described below in detail with reference to the accompanying drawings.

FIG. 3 is a structural schematic diagram of a display substrate for a liquid crystal display device provided by a first embodiment of the present invention. As shown in FIG. 3, the display substrate includes a first base substrate 11, a phase retardation layer 12 and a first alignment layer 13. The phase retardation layer 12 is located above the first base substrate 11, and the first alignment layer 13 is located above the phase retardation layer 12. A direction of phase retardation generated by the phase retardation layer 12 is vertical to a direction of phase retardation generated by liquid crystal in the liquid crystal display device n. The phase retardation layer 12 is configured to perform phase retardation on incident light. As the direction of phase retardation generated by the phase retardation layer 12 is vertical to the direction of phase retardation generated by the liquid crystal, the phase retardation caused by the liquid crystal may be counteracted by the phase retardation caused by the phase retardation layer 12.

The display substrate may be a color filter substrate. When the display substrate is applied in a liquid crystal display device, the liquid crystal display device may include a display substrate and an opposed substrate which are arranged opposite to each other. Liquid crystal is provided between the display substrate and the opposed substrate. The opposed substrate may include a second base substrate and a second alignment layer located above the second base substrate. A liquid crystal layer is provided between the first alignment layer and the second alignment layer to align liquid crystal molecules in the liquid crystal layer through the first alignment layer and the second alignment layer. The opposed substrate may be an array substrate.

There may be a difference between amount of the phase retardation (i.e., an optical path difference) generated by the phase retardation layer 12 and that of the phase retardation generated by the liquid crystal layer, or amount of the phase retardation generated by the phase retardation layer 12 may be equal to that of the phase retardation generated by the liquid crystal layer. An absolute value of the difference may be less than or equal to 50 nm and greater than 0. When the difference is within this range, a better effect of avoiding dark-state light leakage may be realized. Preferably, the amount of the phase retardation generated by the phase retardation layer 12 is equal to that of the phase retardation generated by the liquid crystal layer. In this case, the dark-state light leakage may be completely avoided. The phase retardation R satisfies the following equation: R=Δn×d, where Δn denotes a birefraction index of the material forming this layer and d denotes the thickness of this layer. Usually, Δn of the material is fixed, so the difference may be controlled by controlling the thickness d of the liquid crystal layer or the phase retardation layer.

The phase retardation layer 12 includes a third alignment layer 121 and a liquid crystal polymer layer 122 located above the third alignment layer 121. When the display substrate is a color filter substrate, a black matrix and color matrix patterns are formed above the first base substrate 11. The color matrix patterns are located among lines of the black matrix, and edges of each of the color matrix patterns is located above the black matrix, wherein the black matrix and the color matrix patterns are not shown in FIG. 3. The third alignment layer 121 may be located above the color matrix patterns, and the first alignment layer 13 is located above the liquid crystal polymer layer 122. Preferably, the liquid crystal polymer layer 122 may be a thermotropic liquid crystal layer (Reactive Mesogens, RM). The liquid crystal in the liquid crystal layer 3 has a polarity which is the same as or different from that of the liquid crystal polymer in the liquid crystal polymer layer 122. Specifically, the liquid crystal is positive liquid crystal, while the liquid crystal polymer is negative liquid crystal polymer; or, the liquid crystal is negative liquid crystal, while the liquid crystal polymer is positive liquid crystal polymer; or, the liquid crystal is positive liquid crystal, and the liquid crystal polymer is positive liquid crystal polymer; or, the liquid crystal is negative liquid crystal, and the liquid crystal polymer is negative liquid crystal polymer. Preferably, the liquid crystal has a polarity different from that of the liquid crystal polymer. In the liquid crystal display device, as the direction of phase retardation generated by the phase retardation layer 12 is vertical to the direction of phase retardation generated by the liquid crystal, the phase retardation generated by the liquid crystal layer 3 may be counteracted or partially counteracted by the phase retardation generated by the phase retardation layer so that the contrast is improved. Although the counteraction will make the angle of view of the liquid crystal display device narrower, the arrangement of the liquid crystal and liquid crystal polymer of different polarities may expand the angle of view of the liquid crystal display device to a certain extent.

Preferably, the surface of the phase retardation layer 12 is a flat surface, that is, the surface of the liquid crystal polymer layer 122 is a flat surface, so the phase retardation layer 12 may play a role of a planarization layer, so that it is not required to additionally provide a planarization layer in the display substrate, and the process is thus simplified.

Optionally, the display substrate further includes a Photo Spacer (SP). The photo spacer may be located above the phase retardation layer 12, and the first alignment layer 13 is located above the photo spacer. The photo spacer is not shown in FIG. 3.

The third alignment layer 121 aligns the liquid crystal polymer layer 122 so that the direction of an optical axis of the liquid crystal polymer layer 122 is vertical to the direction of an optical axis of the liquid crystal in the liquid crystal layer under a normal state of the display substrate being not subjected to an external force. Thus, the direction of phase retardation generated by the phase retardation layer 12 is vertical to the direction of phase retardation generated by the liquid crystal layer.

In the display substrate for a liquid crystal display device provided by this embodiment, as the direction of phase retardation generated by the phase retardation layer is vertical to the direction of phase retardation generated by the liquid crystal in the liquid crystal display device n, the phase retardation generated by the liquid crystal in the liquid crystal display device is counteracted or partially counteracted by the phase retardation generated by the phase retardation layer. Accordingly, serious dark-state light leakage of the liquid crystal display device is avoided, and the contrast of the liquid crystal display device is improved.

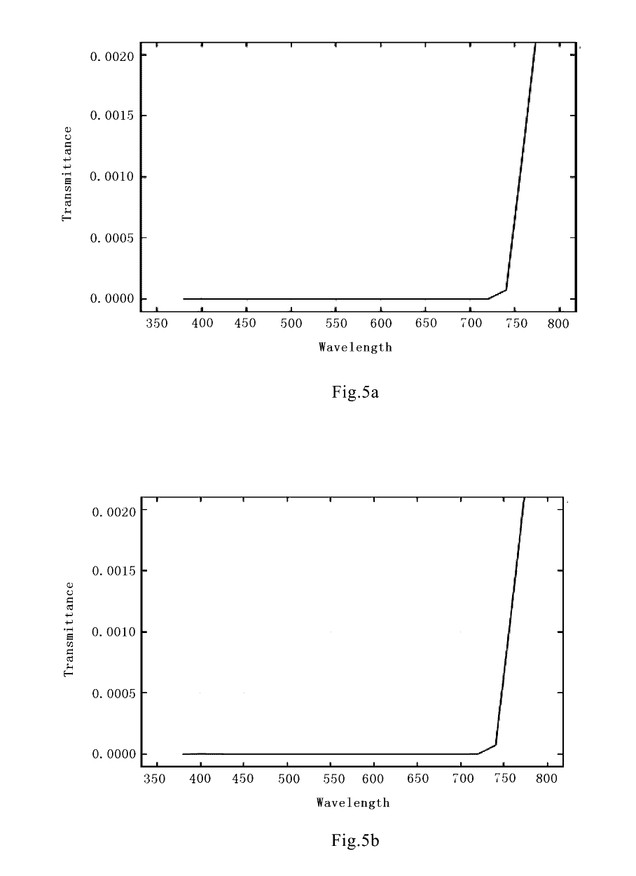

FIG. 4 is a structural schematic diagram of a liquid crystal display device provided by a second embodiment of the present invention. As shown in FIG. 4, the liquid crystal display device includes a display substrate 1 and an opposed substrate 2 which are arranged opposite to each other. A liquid crystal layer 3 is provided between the display substrate 1 and the opposed substrate 2.

The display substrate 1 may be the display substrate provided in the first embodiment. The opposed substrate 2 may include a second base substrate 21 and a second alignment layer 22 located above the second base substrate 21. In this embodiment, the display substrate 1 may be a color filter substrate, and the opposed substrate 2 may be an array substrate. Specifically, the opposed substrate 2 may further include gate lines, data lines, thin film transistors, pixel electrodes, common electrodes and other structures located above the second base substrate 21, and these structures will not be specifically drawn in FIG. 4.

In this embodiment, the liquid display device may include an ADvanced Super Dimension Switch (ADS) liquid crystal display device or an In-Plane Switching (IPS) liquid crystal display device.

The light leakage state of the liquid crystal display device will be described below in detail with reference to FIG. 5a and FIG. 5b. FIG. 5a is a schematic diagram of a light leakage state in the case of the liquid crystal display device of FIG. 4 being not subjected to an external pressure. As shown in FIG. 5a, the liquid crystal display device is not bent when it is not subjected to an external pressure, so the transmittance of the display device within a certain wavelength range is about 0. FIG. 5b is a schematic diagram of a light leakage stage in case of the liquid crystal display device of FIG. 4 being subjected to an external pressure. Assuming that the liquid crystal display device is bent under an external pressure, an included angle between the direction of phase retardation generated by the first base substrate 11 and the direction of phase retardation generated by the liquid crystal layer 3 is 45°, and an included angle between the direction of phase retardation generated by the second base substrate 21 and the direction of phase retardation generated by the liquid crystal in the liquid crystal layer 3 is 135°. The direction of phase retardation generated by the first base substrate 11 is vertical to the direction of phase retardation generated by the second base substrate 21, and the amount of the phase retardation generated by the first base substrate 11 is equal to that of the phase retardation generated by the second base substrate 21 (for example, each of the both is 3 nm), so the phase retardations generated by the two base substrates counteract to each other. In addition, as a phase retardation layer 12 is provided in the display substrate 1, the phase retardation generated by the liquid crystal layer 3 is counteracted by the phase retardation generated by the phase retardation layer 12. Accordingly, the transmittance of the liquid crystal display device within a certain wavelength range is about 0, as shown in FIG. 5b. In other words, compared with the prior art, the liquid crystal display device provided by this embodiment of the present invention avoids the occurrence of serious dark-state light leakage.

In the liquid crystal display device provided by this embodiment, as the direction of phase retardation generated by the phase retardation layer is vertical to the direction of phase retardation generated by the liquid crystal layer, the phase retardation generated by the liquid crystal layer is counteracted or partially counteracted by the phase retardation generated by the phase retardation layer, thereby avoiding serious dark-state light leakage and improving the contrast of the liquid crystal display device.

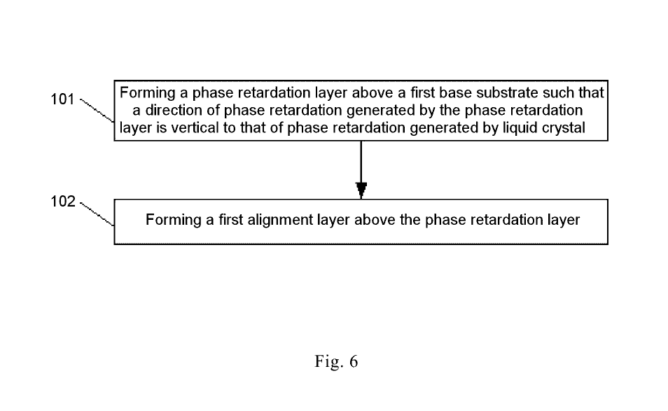

FIG. 6 is a flowchart of a method for manufacturing a display substrate for a liquid display device provided by a third embodiment of the present invention. As shown in FIG. 6, the method includes the following steps 101 to 102.

Step 101: forming a phase retardation layer above a first base substrate such that a direction of phase retardation generated by the phase retardation layer is vertical to a direction of phase retardation generated by liquid crystal in the liquid crystal display device.

In this embodiment, the phase retardation layer includes a third alignment layer and a liquid crystal polymer layer. Accordingly, step 101 specifically includes:

step 1011: forming the third alignment layer above the first base substrate; and

step 1012: forming the liquid crystal polymer layer above the third alignment layer.

The liquid crystal polymer layer may include a thermotropic liquid crystal layer or a lyotropic liquid crystal layer. Preferably, the liquid crystal polymer layer includes a thermotropic liquid crystal layer. In this case, step 1012 may specifically include: forming a thermotropic liquid crystal material layer on the third alignment layer, heating the thermotropic liquid crystal material layer, and performing UV exposure on the heated thermotropic liquid crystal material layer to form a thermotropic liquid crystal layer.

Step 102: forming a first alignment layer above the phase retardation layer.

The method for manufacturing a display substrate for a liquid crystal display device provided by this embodiment may be used for manufacturing the display substrate provided by the first embodiment, and the specific description of the display substrate may be seen from the first embodiment and will not be repeated here.

In the method for manufacturing a display substrate for a liquid crystal display device provided by this embodiment, as the direction of phase retardation generated by the phase retardation layer is vertical to the direction of phase retardation generated by the liquid crystal, the phase retardation generated by the liquid crystal layer is counteracted or partially counteracted by the phase retardation generated by the phase retardation layer, thereby avoiding serious dark-state light leakage and improving the contrast of the liquid crystal display device.

It should be understood that, the foregoing implementations are merely exemplary implementations used for describing the principle of the present invention, but the present invention is not limited thereto. A person of ordinary skill in the art may make various variants and improvements without departing from the spirit and essence of the present invention, and those variants and improvements shall fall into the protection scope of the present invention.

1-10. (canceled)

11. A display substrate for a liquid crystal display device, comprising a first base substrate, a phase retardation layer and a first alignment layer, wherein the phase retardation layer is located above the first base substrate, and the first alignment layer is located above the phase retardation layer; and
the phase retardation layer is configured to perform phase retardation on light entering the phase retardation layer, and a direction of phase retardation generated by the phase retardation layer is vertical to a direction of phase retardation generated by a liquid crystal layer in the liquid crystal display device.

12. The display substrate according to claim 11, wherein the phase retardation layer comprises a third alignment layer and a liquid crystal polymer layer located above the third alignment layer; and in the case of the display substrate being not subjected to an external force, a direction of an optical axis of a liquid crystal polymer in the liquid crystal polymer layer is vertical to a direction of an optical axis of liquid crystal in the liquid crystal layer.

13. The display substrate according to claim 12, wherein the liquid crystal in the liquid crystal layer has a polarity which is the same as that of the liquid crystal polymer in the liquid crystal polymer layer.

14. The display substrate according to claim 12, wherein the liquid crystal in the liquid crystal layer has a polarity which is different from that of the liquid crystal polymer in the liquid crystal polymer layer.

15. The display substrate according to claim 12, wherein the liquid crystal polymer layer is a thermotropic liquid crystal layer or a lyotropic liquid crystal layer.

16. The display substrate according to claim 13, wherein the liquid crystal polymer layer is a thermotropic liquid crystal layer or a lyotropic liquid crystal layer.

17. The display substrate according to claim 14, wherein the liquid crystal polymer layer is a thermotropic liquid crystal layer or a lyotropic liquid crystal layer.

18. The display substrate according to claim 11, wherein there is a difference between amount of the phase retardation generated by the phase retardation layer and that of the phase retardation generated by the liquid crystal layer.

19. The display substrate according to claim 18, wherein an absolute value of the difference is less than or equal to 50 nm and greater than 0.

20. The display substrate according to claim 11, wherein amount of the phase retardation generated by the phase retardation layer is equal to that of the phase retardation generated by the liquid crystal layer.

21. A liquid crystal display device, comprising a display substrate and an opposed substrate which are arranged opposite to each other, wherein a liquid crystal layer is provided between the display substrate and the opposed substrate;
The display substrate is the display substrate according to claim 11; and
the opposed substrate comprises a second base substrate and a second alignment layer located above the second base substrate.

22. The liquid crystal display device according to claim 21, wherein the liquid crystal display device comprises an advanced super dimension switch liquid crystal display device or an in-plane switching liquid crystal display device.

23. The liquid crystal display device according to claim 21, wherein the phase retardation layer comprises a third alignment layer and a liquid crystal polymer layer located above the third alignment layer; and in the case of the display substrate being not subjected to an external force, a direction of an optical axis of a liquid crystal polymer in the liquid crystal polymer layer is vertical to a direction of an optical axis of liquid crystal in the liquid crystal layer.

24. The liquid crystal display device according to claim 23, wherein the liquid crystal in the liquid crystal layer has a polarity which is the same as that of the liquid crystal polymer in the liquid crystal polymer layer.

25. The liquid crystal display device according to claim 23, wherein the liquid crystal in the liquid crystal layer has a polarity which is different from that of the liquid crystal polymer in the liquid crystal polymer layer.

26. The liquid crystal display device according to claim 21, wherein there is a difference between amount of the phase retardation generated by the phase retardation layer and that of the phase retardation generated by the liquid crystal layer.

27. The liquid crystal display device according to claim 26, wherein an absolute value of the difference is less than or equal to 50 nm and greater than 0.

28. The liquid crystal display device according to claim 21, wherein amount of the phase retardation generated by the phase retardation layer is equal to that of the phase retardation generated by the liquid crystal layer.

29. A method for manufacturing a display substrate for a liquid crystal display device, comprising the following steps of:
forming a phase retardation layer above a first base substrate, a direction of phase retardation generated by the phase retardation layer being vertical to a direction of phase retardation generated by a liquid crystal layer in the liquid crystal display device; and
forming a first alignment layer above the phase retardation layer.

30. The method for manufacturing a display substrate according to claim 29, wherein the phase retardation layer comprises a third alignment layer and a liquid crystal polymer layer,
the step of forming the phase retardation layer above the first base substrate comprises:
forming the third alignment layer above the first base substrate; and
forming the liquid crystal polymer layer above the third alignment layer,
wherein the third alignment layer is formed such that a direction of an optical axis of liquid crystal polymer in the liquid crystal polymer layer above the third alignment layer is vertical to a direction of an optical axis of liquid crystal in the liquid crystal layer.
